(19) United States
(12) Patent Application Publication
(10) Pub. No.: US 2009/0158569 A1
(43) Pub. Date: Jun. 25, 2009

(54) INSTALLATION TOOL AND CORRECTION TOOL FOR HELICAL COIL INSERT

(75) Inventor: Tsutomu Yui, Tokyo (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/303,430

(22) PCT Filed: May 15, 2007
(86) PCT No.: PCT/JP2007/060321

§ 371 Date: Dec. 4, 2008

(30) Foreign Application Priority Data
Jun. 6, 2006 (JP) 2006-157763

(51) Int. Cl. B23P 19/04

(52) U.S. Cl. 29/240.5

(57) ABSTRACT

An installation tool is used when a helical coil insert having a diamond-shaped cross section is inserted into an internally threaded part. The installation tool (10) has a rod-shaped tool shaft (11). The tool shaft (11) has a tang pincer (13) for threadably inserting a helical coil insert (21) into an internally threaded part (23) and bending a tang (22).

### TECHNICAL FIELD

The present invention relates to an installation tool used when a helical coil insert of diamond-shaped cross section is inserted into an internally threaded part, as well as to a correction tool used when the installed helical coil insert is corrected.

### BACKGROUND ART

When a steel bolt is threadably inserted into an internally threaded part (female thread part) formed in a member made of aluminum or another such soft material, the internally threaded part sometimes deforms.

One corrective measure is to form an internally threaded part with a somewhat large diameter in the soft material, to insert a steel helical coil insert having a diamond-shaped cross section into the internally threaded part, and to form a new internally threaded part using this helical coil insert. Since the helical coil insert is made of steel, the new thread is more rigid and deformation is not a concern.

Helical coil inserts are formed by winding a steel wire having a diamond-shaped cross section, with one end of the winding bending towards the center. This bent portion is referred to as a tang. This tang is held with a tool and is inserted into the internally threaded part while the helical coil insert is rotated.

After insertion, the tang is an unnecessary hindrance. Since a notch is formed in the base of the tang, the tang can be broken off at the notch and removed by shaking the distal end of the tang.

A specialized tool disclosed in, e.g., Japanese Patent Laid-Open Publication No. 11-156751 (JP 11-156751 A) is needed to remove the tang. This specialized tool is described hereinbelow with reference to FIGS. 12A through 12C hereof.

As shown in FIG. 12A, a tang-breaking tool 100 is composed of a sleeve 102 mounted on the top surface of a member 101, a shaft 104 that is enclosed within the sleeve 102 and that protrudes out through a bottom part 103 at one end (bottom end), a handle 105 provided at the top end of the shaft 104, and a hook 107 swingably attached to the bottom end of the shaft 104 by means of a pin 106.

A helical coil insert 108 is inserted in advance into the member 101. A tang 109 provided at one end of the helical coil insert 108 is located deep within the hole. To bend the tang 109, the handle 105 is lowered to lower the shaft 104.

When brought into contact with the tang 109, the hook 107 rotates counterclockwise in the diagram around the pin 106, as shown in FIG. 12B. The shaft can continue to be lowered.

Next, when the hook 107 falls below the tang 109, the hook rotates by its own weight clockwise in the diagram around the pin 106, as shown in FIG. 12C. The tang 109 can then be bent with the hook 107 if the shaft 104 is pulled up.

The tang 109 must be powerfully pulled up with the hook 107 in order to bend the tang 109. It is difficult to regulate this force. If the upward force is too great, a first coil 111 of the helical coil insert 108 separates from the internally threaded part 112 as shown by the broken lines in FIG. 13.

In conventional practice, an inspection is conducted, and the helical coil insert 108 is replaced with a new insert if the first coil 111 has separated. The helical coil insert then becomes useless and replacement costs are incurred.

An installation tool for inserting the helical coil insert 108 into the internally threaded part 112 and a tang-breaking tool 100 for bending the tang are also required, and therefore the number of tools increases.

In view of this, there is a need for a multifunction tool whereby the helical coil insert can be used effectively and the number of tools can be reduced.

### DISCLOSURE OF THE INVENTION

According to a first aspect of the present invention, there is provided a helical coil insert installation tool for use in installing a helical coil insert into an internally threaded part, the helical coil insert being formed by winding a wire of diamond cross section into a coil and having one end extending into a center of the coil to provide a tang, the helical coil insert installation tool comprising: a rod-shaped tool shaft; a tang pincer provided at one end of the tool shaft for pinching the tang when the helical coil insert is threadedly inserted into the internally threaded part or when the tang is folded over; a hook provided on the tool shaft for hooking onto a distal end positioned next to the tang of the helical coil insert; and a handle provided at an opposite end of the tool shaft for turning the tool shaft when the helical coil insert is threadedly inserted into the internally threaded part.

The tang is pinched by the tang pincer, and the tool shaft is turned with the handle, whereby the helical coil insert is threadably inserted into the internally threaded part. The tool shaft then moves in the axial direction while the tang is pinched by the tang pincer. The tang can thereby be removed from the helical coil insert. If a first winding of the helical coil insert separates from the internally threaded part, the first winding is hooked and returned to the internally threaded part by the hook.

Thus, according to the invention, a multifunction took is provided, wherein three different operations can be carried out with one tool.

If the first winding of the helical coil insert separates from the internally threaded part, the helical coil insert does not need to be replaced with a new insert because the first winding can be returned to the internally threaded part by the hook. Therefore, the helical coil insert can be used effectively.

Preferably, the tool shaft has a cylindrical weight disposed on the tool shaft and vertically slidable therealong to impart an impact to the shaft tool to thereby guide the distal end of the helical coil insert into the internally threaded part when the distal end is displaced from the internally threaded part.

When the first winding of the helical coil insert has separated from the internally threaded part, the first winding often rests on the crest of the internally threaded part. When the portion resting on the crest is subjected to an impact, this portion easily fits into the recession of the internally threaded part. Specifically, the helical coil insert can be easily corrected by creating a force of impact with the cylindrical weight.

In a preferred form, the hook comprises a groove formed by cutting out a part of the tool shaft. Since there is no need to prepare new material to form the groove, the cost of the helical coil insert installation tool can be reduced.

Desirably, the hook comprises a projection formed protruding in an axially perpendicular direction from the tool shaft. The projection can be seen through the entrance in the internally threaded part. The operation is simplified because the projection can easily hook onto the helical coil insert.

According to a second aspect of the present invention, there is provided a helical coil insert correction tool for returning a first winding of a helical coil insert to an internally threaded part when the first winding has separated from the internally threaded part, the helical coil insert correction tool comprising: a rod-shaped tool shaft; and hooks that are provided to the tool shaft and that hook onto one end of the helical coil insert.

The helical coil insert correction tool is a simple tool having merely a hook provided to a rod-shaped tool shaft. Since the structure is simple, the cost of the helical coil insert correction tool can be reduced.

Preferably, the tool shaft has a cylindrical weight disposed on the tool shaft and vertically slidable therealong to impart an impact to the shaft tool to thereby guide the distal end of the helical coil insert into the internally threaded part when the distal end is displaced from the internally threaded part.

When the first winding of the helical coil insert has separated from the internally threaded part, the first winding rests on the crest of the internally threaded part. When this portion is subjected to impact, this portion easily fits into the recession of the internally threaded part. Specifically, the helical coil insert can be easily corrected by creating a force of impact with the cylindrical weight.

In a preferred form, the hook comprises a projection formed protruding in an axially perpendicular direction from the axis of the tool shaft. The projection can be seen through the entrance of the internally threaded part. The operation is simplified because the projection easily hooks on the helical coil insert.

Desirably, the hooks are provided to both ends of the tool shaft, and one hook is larger than the other hook.

The member has two internally threaded parts, a small-diameter threaded part and a large-diameter threaded part; and a single helical coil insert correction tool can be used to make a correction in cases in which the distal end of the helical coil insert has separated from both internally threaded parts. Consequently, it is possible to create a helical coil insert correction tool having multiple functions.

### BRIEF DESCRIPTION OF THE DRAWINGS

FIG. 1 is a perspective view illustrating a helical coil insert installation tool according to the present invention;

FIGS. 2A and 2B are schematic views illustrating a helical coil insert being threadably inserted into an internally threaded part;

FIGS. 3A and 3B are schematic views illustrating a bent tang;

FIG. 4 is a schematic view illustrating the helical coil insert being corrected after separation from the internally threaded part;

FIG. 5A is a schematic view illustrating the shape of a projection of the tool;

FIG. 5B is a cross-sectional view taken along line b-b of FIG. 5A;

FIG. 6 is a perspective view showing a modification of the helical coil insert installation tool according to the present invention;

FIG. 7 is a schematic view illustrating an operation of the helical coil insert installation tool shown in FIG. 6;

FIG. 8 is a perspective view illustrating a helical coil insert correction tool according to the present invention;

FIG. 9 is a schematic view illustrating an operation of the helical coil insert correction tool;

FIG. 10 is a perspective view showing a modification of the helical coil insert correction tool according to the present invention;

FIG. 11 is a perspective view showing another modification of the helical coil insert correction tool according to the present invention;

FIGS. 12A through 12C are schematic views illustrating the basic principle of a conventional technique; and

FIG. 13 is a schematic view illustrating one end of a conventional helical coil insert.

### BEST MODE FOR CARRYING OUT THE INVENTION

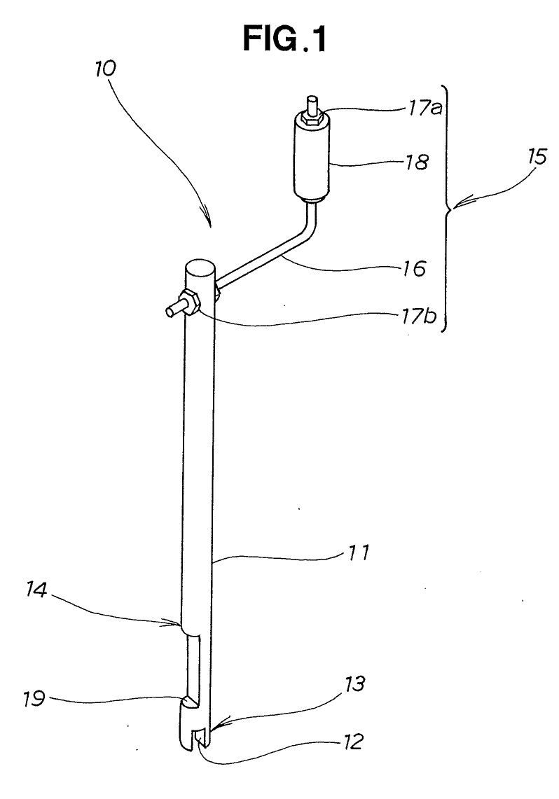

In FIG. 1, a helical coil insert installation tool 10 is composed of a rod-shaped tool shaft 11, a tang pincer 13 formed at one end of the tool shaft 11 and provided with a tang groove 12 for pinching the tang when the helical coil insert is threadably inserted into the internally threaded part or when the tang is folded over, a hook 14 that is formed in the tool shaft 11 and that hooks onto one end of the helical coil insert, and a handle 15 that is provided to the other end of the tool shaft 11 and that turns the tool shaft 11 when the helical coil insert is threadably inserted into the internally threaded part.

The handle 15 is composed of an L-shaped handle shaft 16, a handle grip 18 that can be grasped by an operator, a nut 17a for fixing the handle grip 18 to the handle shaft 16, and a nut 17b for fixing one end of the handle shaft 16 to the tool shaft 11.

The hook 14 is, e.g., a groove 19 formed by cutting out a part of the tool shaft 11.

The following is a description of the action of the helical coil insert installation tool 10 having the configuration described above.

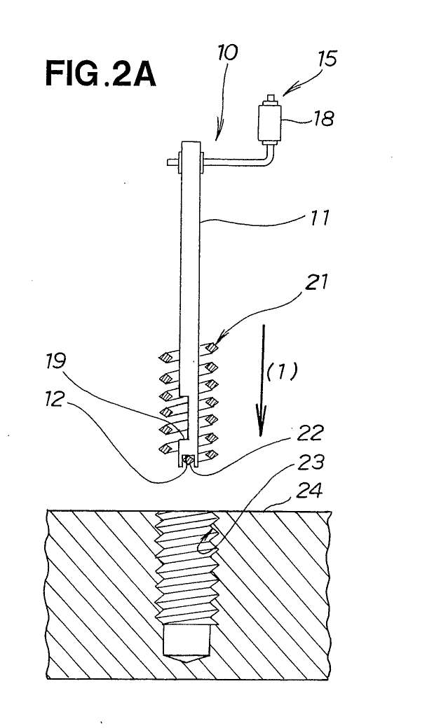

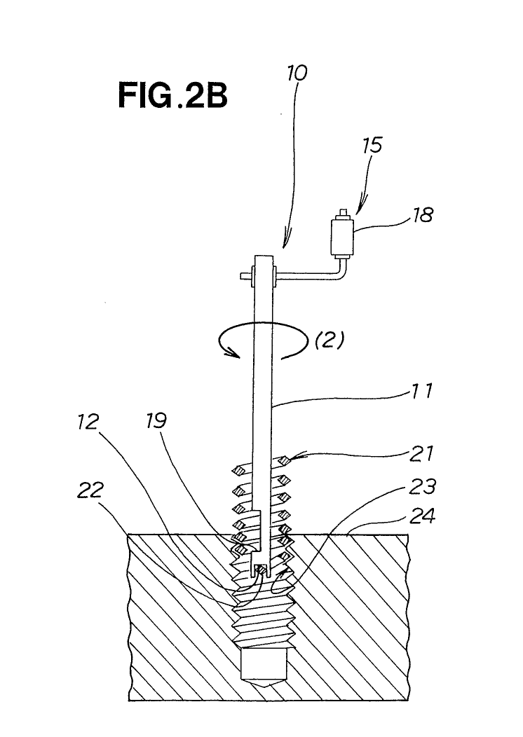

A helical coil insert 21 is a metal component wherein a coil having a diamond-shaped cross section is wound into a coil shape, and one end of the wire extends into the center of the coil to form a tang 22, as shown in FIG. 2A. The tang 22 is therefore held in the tang groove 12 in the helical coil insert installation tool 10. The helical coil insert installation tool 10 is then lowered towards a workpiece 24 comprising an internally threaded part 23 as shown by the arrow (1). The operator manually supports the helical coil insert 21 at this time. When the helical coil insert 21 comes into contact with the top surface of the workpiece 24, the operator grasps the handle grip 18 and turns the tool shaft 11 as shown by the arrow (2) in FIG. 2B. The helical coil insert 21 then enters the internally threaded part 23 while rotating.

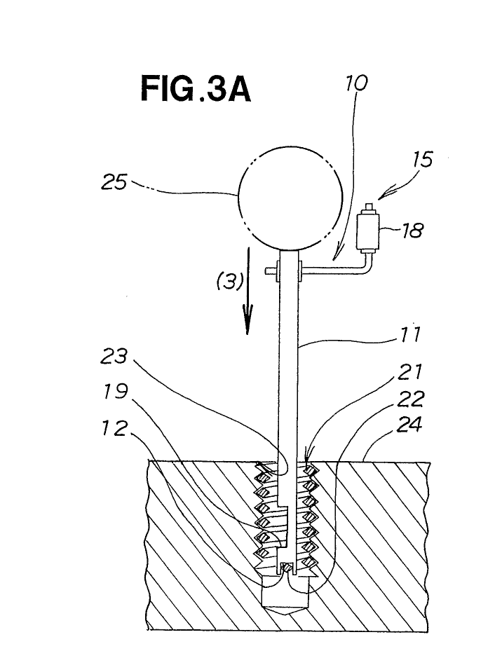

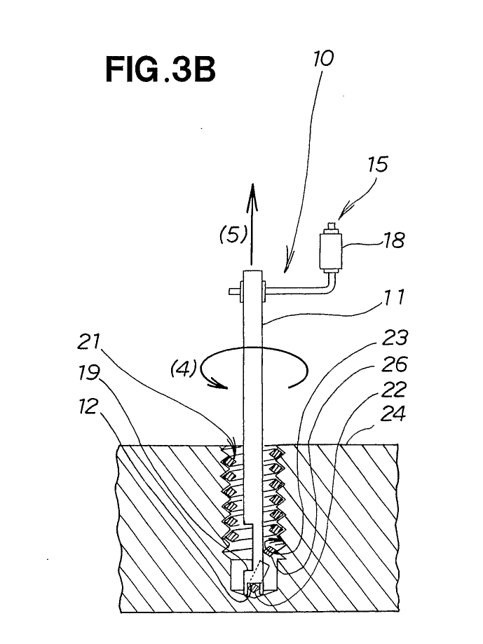

When the helical coil insert 21 is threadably inserted into the internally threaded part 23 as shown in FIG. 3A, the top end of the tool shaft 11 is struck with a hammer 25 shown by the broken lines in the direction of the arrow (3). Downward force is thereby applied to the tang 22.

As a result, the tang 22 bends and separates from the helical coil insert 21 as shown in FIG. 3B. A large amount of downward force must be applied to the tang 22 in order to bend the tang 22. If this force is too great, a first winding 26 of the helical coil insert 21 may separate from the internally threaded part 23.

The fact that the first winding 26 has separated from the internally threaded part 23 can be confirmed by viewing the internally threaded part 23 from above.

When it is determined that the first winding 26 has separated from the internally threaded part 23, the tool shaft 11 is turned as shown by the arrow (4). The tool shaft 11 is then raised as shown by the arrow (5), and the groove 19 is made to face the first winding 26.

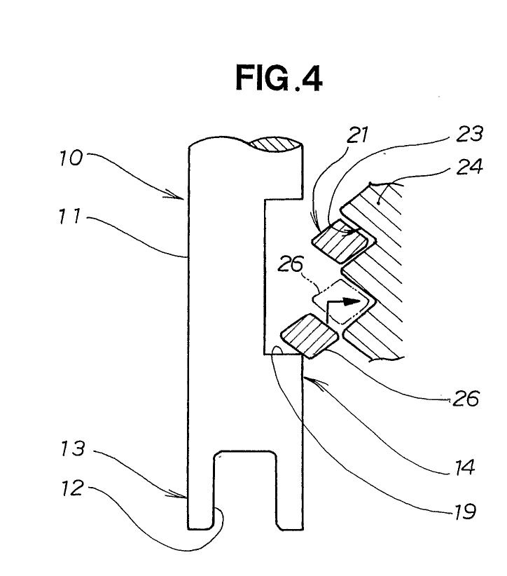

The groove 19 then hooks onto the first winding 26, as shown in FIG. 4. The tool shaft 11 is then moved upward in the diagram, whereby the first winding 26 is returned to the internally threaded part 23 as shown by the broken lines.

As described above, the helical coil insert installation tool 10 can be used to carry out three steps, including a step for threadably inserting the helical coil insert 21 into the internally threaded part 23, a step for bending the tang 22, and a step for returning the first winding 26 to the internally threaded part 23.

The groove 19 for carrying out a correction step is a groove formed by cutting out a recession in the tool shaft 11 orthogonal to the axial direction. Since new material does not need to be prepared in order to form the groove 19, the cost of the helical coil insert installation tool 10 can be reduced.

In the example above, the hook 14 is composed of the groove 19, but the hook 14 can also be embodied in another form. Another embodiment is described in the following diagram.

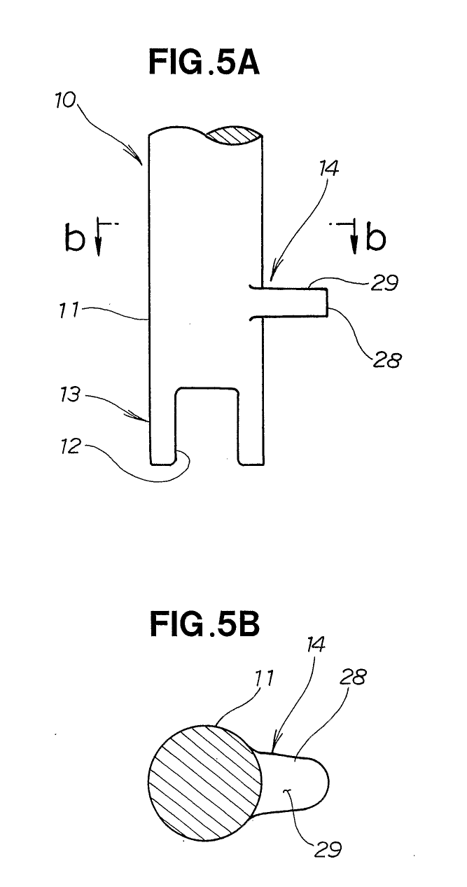

The hook 14 may be a projection 28 such as is shown in FIG. 5B, which is a cross-sectional view along the line b-b in FIG. 5A. The projection 28 is formed protruding from the tool shaft 11 as shown in FIG. 5A. The top surface 29 of this projection 28 can easily be confirmed visually when the internally threaded part is viewed. Therefore, the correction step can be more easily carried out.

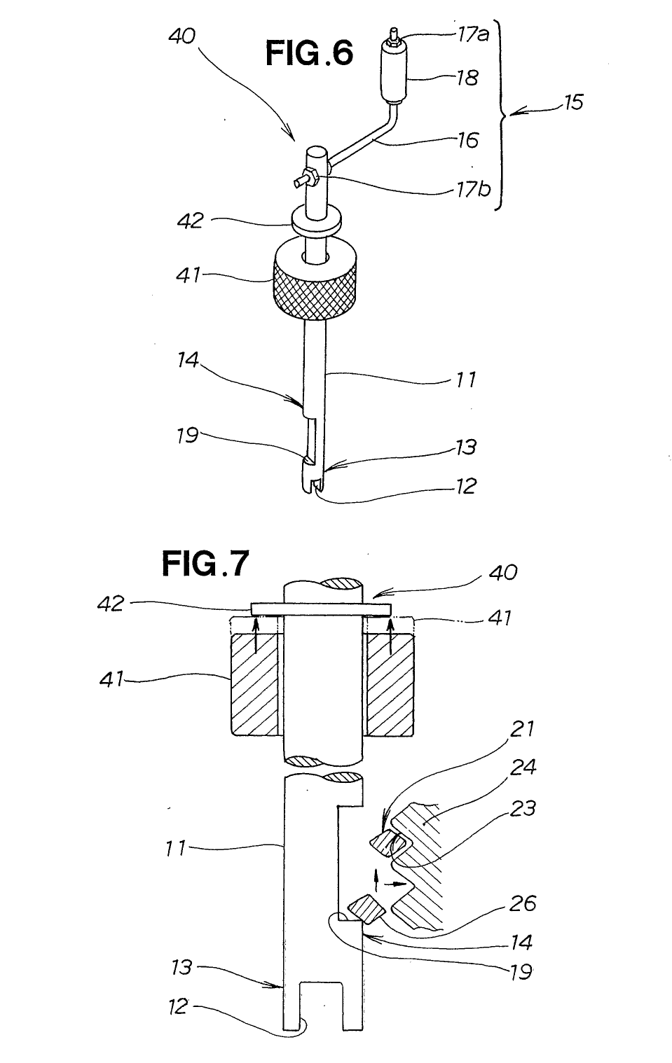

Next, a modification of the helical coil insert installation tool will be described in FIGS. 6 and 7. Components similar to those in FIG. 1 are denoted by the same numerical symbols and are not described.

A cylindrical weight 41 for subjecting the tool shaft 11 to impact in the pulling direction of the hook 14 is provided to a helical coil insert installation tool 40 to be capable of moving in the axial direction, as shown in FIG. 6. A stopper 42 that corresponds to the cylindrical weight 41 is integrally formed on the tool shaft 11.

The groove 19 hooks onto the first winding 26 of the helical coil insert 21, as shown in FIG. 7. Next, the cylindrical weight 41 collides with the stopper 42 as shown by the arrows. This impact causes the tool shaft 11 to move upward in the diagram, whereby the first winding 26 can be returned to the internally threaded part 23 as shown by the arrows.

Specifically, the first winding 26 that has separated from the internally threaded part 23 often rests on the crest of the internally threaded part 23. When this portion resting on the crest is subjected to impact, this portion easily fits into the recession of the internally threaded part 23. Specifically, the helical coil insert 21 can be easily corrected by creating a force of impact with the cylindrical weight 41.

With the helical coil insert installation tools 10, 40 described above, one tool can be used to carry out three steps, including a step for threadably inserting the helical coil insert 21 into the internally threaded part 23, a step for bending the tang 22, and a step for returning the first winding 26 to the internally threaded part 23.

Although the threadable insertion step and the step for bending the tang are vital, the correction step is not always necessary. One possibility, which is thought to increase operating efficiency, is to perform the correction step as necessary separately from the threadable insertion step and the step for bending the tang.

To perform the steps separately, a specialized tool for the correction step is preferably prepared in addition to the helical coil insert installation tools 10, 40.

In view of this, the following is a description of a helical coil insert correction tool as this specialized tool for the correction step.

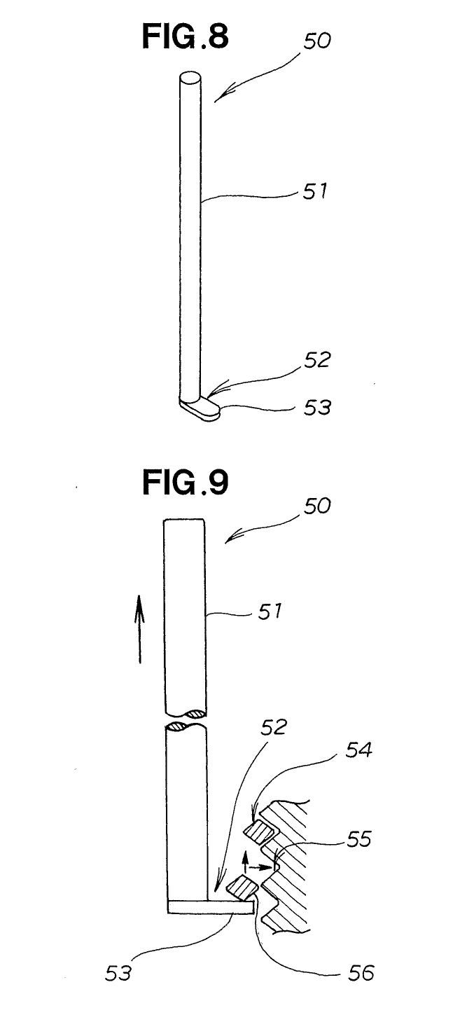

As shown in FIG. 8, a helical coil insert correction tool 50 is composed of a rod-shaped tool shaft 51, and a hook 52 that is provided to the tool shaft 51 and that hooks onto one end of the helical coil insert. The hook 52 is preferably a projection 53.

The projection 53 then hooks onto a first winding 56 of a helical coil insert 54 in FIG. 9. The tool shaft 51 is then moved upward in the diagram to return the first winding 56 to an internally threaded part 55.

The helical coil insert correction tool 50 is configured from the rod-shaped tool shaft 51 and the projection 53, and therefore has a simple structure. Therefore, the cost of the helical coil insert correction tool 50 can be reduced. If a projection 53 is used, the projection can be visually inspected with ease through the internally threaded part 55. Therefore, the projection 53 can easily hook onto the first winding 56.

The helical coil insert correction tool 50 may also be a helical coil insert correction tool 50B or 50C in the embodiments described below.

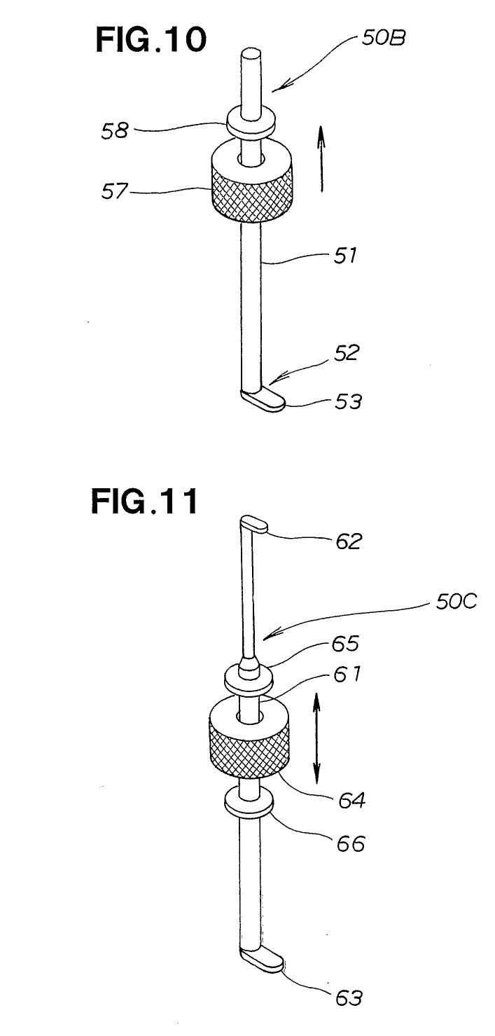

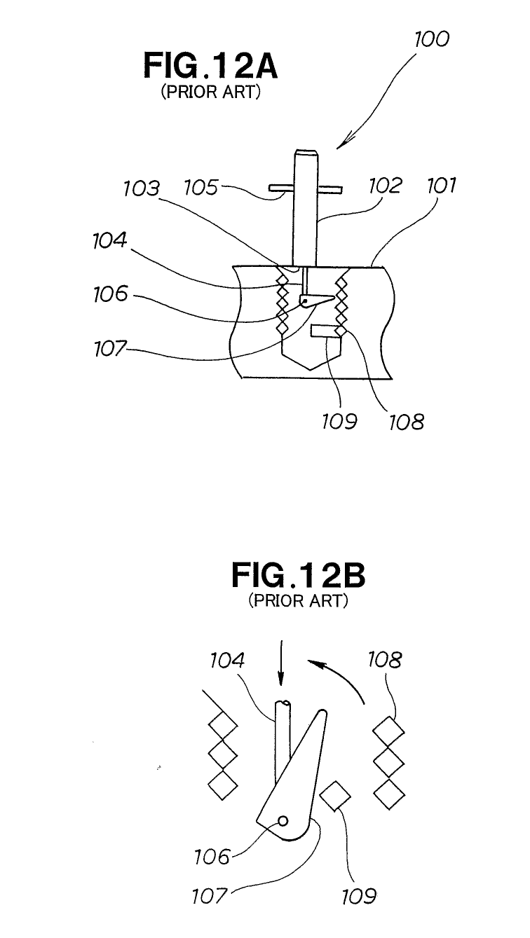

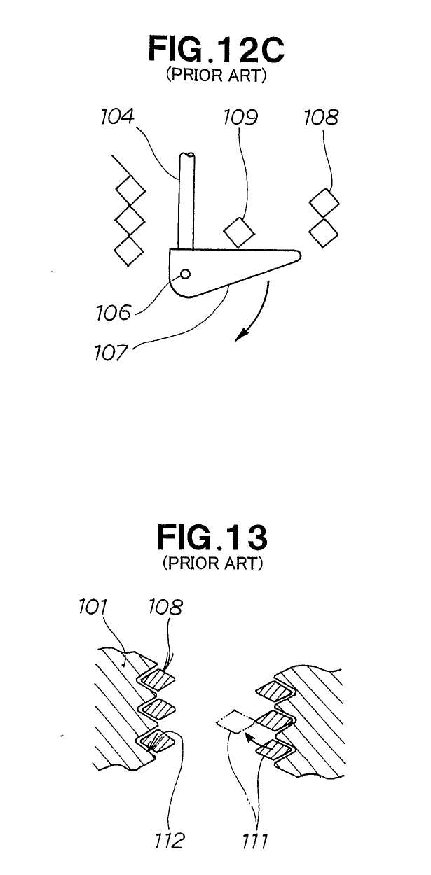

A cylindrical weight 57 for subjecting the tool shaft 51 to impact in the pulling direction of the hook 52 is provided to a helical coil insert correction tool 50B while allowed to move in the axial direction of the tool shaft 51, as shown in FIG. 10. A stopper 58 that corresponds to the cylindrical weight 57 is integrally formed on the tool shaft 51.

When the cylindrical weight 57 collides with the stopper 58, the projection 53 subjects the helical coil insert to impact and returns the helical coil insert to the internally threaded part.

The helical coil insert correction tool 50C has a small hook 62 provided to one end of a tool shaft 61, and a large hook 63 provided to the other end of the tool shaft 61, as shown in FIG. 11. A cylindrical weight 64 is provided in the middle of the tool shaft 61, and a pair of stoppers 65, 66 is provided to the tool shaft 61 so as to sandwich the cylindrical weight 64.

The workpiece has two internally threaded parts, a small-diameter threaded part and a large-diameter threaded part; and a single helical coil insert correction tool 50C can be used to make a correction in cases in which the distal end of the helical coil insert has separated from both internally threaded parts. Consequently, it is possible to create a helical coil insert correction tool having multiple functions.

Instead of a round bar, the tool shaft may be a square or hexagonal bar, and the cross-sectional shape thereof is arbitrary. Instead of a cylinder, the cylindrical weight may be a square or polygonal block, and the cross-sectional shape thereof is arbitrary.

The projection was described as being integrated on the tool shaft in the embodiments, but the projection may also be formed as a protrusion fixed in place on the tool shaft by welding or bolts. The protrusion is not limited to being integrated on the tool shaft or subsequently attached.

### INDUSTRIAL APPLICABILITY

As described above, the present invention can be used as a tool in the operation of installing a helical coil insert in an internally threaded part.

1. A helical coil insert installation tool for use in installing a helical coil insert into an internally threaded part, the helical coil insert being formed by winding a wire of diamond cross section into a coil and having one end extending into a center of the coil to provide a tang, the helical coil insert installation tool comprising:
a rod-shaped tool shaft;
a tang pincer provided at one end of the tool shaft for pinching the tang when the helical coil insert is threadedly inserted into the internally threaded part or when the tang is folded over;
a hook provided on the tool shaft for hooking onto a distal end positioned next to the tang of the helical coil insert; and
a handle provided at an opposite end of the tool shaft for turning the tool shaft when the helical coil insert is threadedly inserted into the internally threaded part.

2. The installation tool of claim 1, wherein the tool shaft has a cylindrical weight disposed on the tool shaft and vertically slidable therealong to impart an impact to the shaft tool to thereby guide the distal end of the helical coil insert into the internally threaded part when the distal end is displaced from the internally threaded part.

3. The installation tool of claim 1, wherein the hook comprises a groove obtained by cutting out part of the tool shaft.

4. The installation tool of claim 1, wherein the hook comprises a projection formed protruding in an axially perpendicular direction from an axis of the tool shaft.

5. A helical coil insert correction tool for returning a first winding of a helical coil insert to an internally threaded part when the first winding has separated from the internally threaded part, comprising:
a rod-shaped tool shaft; and
hooks provided on the tool shaft for hooking onto one end of the helical coil insert.

6. The correction tool of claim 5, wherein the tool shaft has a cylindrical weight disposed on the tool shaft and vertically slidable therealong to impart an impact to the shaft tool to thereby guide the distal end of the helical coil insert into the internally threaded part when the distal end is displaced from the internally threaded part.

7. The correction tool of claim 5, wherein the hook comprises a groove obtained by cutting out part of the tool shaft.

8. The correction tool of claim 5, wherein the hook comprises a projection formed protruding in an axially perpendicular direction from an axis of the tool shaft.

9. The correction tool of claim 5, wherein the hooks are provided on both ends of the tool shaft, and one hook is larger than other hook.
